(19) United States
(12) Patent Application Publication
(10) Pub. No.: US 2009/0136719 A1
(43) Pub. Date: May 28, 2009

(54) SURFACE GRAFT MATERIAL AND ITS MANUFACTURING METHOD, ELECTRICALLY CONDUCTIVE MATERIAL AND ITS MANUFACTURING METHOD, AND ELECTRICALLY CONDUCTIVE PATTERN MATERIAL

(75) Inventors: Koichi Kawamura, Kanagawa (JP); Hiroshi Sato, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/910,270

(22) PCT Filed: Mar. 31, 2006
(86) PCT No.: PCT/JP2006/307401

§ 371 Date: Sep. 30, 2007

(30) Foreign Application Priority Data
Mar. 31, 2005 (JP) 2005-105209
Mar. 31, 2005 (JP) 2005-105210

(51) Int. Cl. B05D 5/12; B05D 7/00; B32B 27/08

(52) U.S. Cl. 428/195.1; 427/412.1; 427/58; 428/411.1

(57) ABSTRACT

The present invention provides a method for manufacturing a surface graft material including forming an insulator layer containing an insulating resin and a polymerization initiator on a substrate, and forming a graft polymer directly bonding to the surface of the insulator layer, a surface graft material manufactured by this method, a method for manufacturing an electrically conductive material including forming an insulator layer containing an insulating resin and a polymerization initiator on a substrate, forming a graft polymer directly bonding to the surface of the insulator layer, and forming an electrically conductive layer on the graft polymer, an electrically conductive material manufactured by this method, and an electrically conductive pattern material obtained by etching the electrically conductive material.

### TECHNICAL FIELD

The present invention relates to a surface graft material useful for forming an electrically conductive material and its manufacturing method, an electrically conductive material and its manufacturing method, and an electrically conductive pattern material. Specifically, the invention relates to a surface graft material useful for forming fine metal wiring or an electrically conductive film usable in the field of electronic materials, especially coppered laminates used to form metal wiring boards and printed wiring boards, and its manufacturing method, an electrically conductive material and its manufacturing method, and an electrically conductive pattern material.

### BACKGROUND ART

Known metal pattern forming methods useful in the field of conventional electrically conductive patterns, especially printed wiring boards, mainly include a subtractive method, a semi-additive method, and a full additive method. In the subtractive method, a photosensitive layer sensitive to active rays is formed on a metal layer provided on a substrate, image-wise exposed to light, and developed to form a resist image, and the metal layer is then etched to form a metal pattern, and the resist image is finally removed. The surface of the substrate used in this method is roughened and the anchor effect due to the roughening allows adhesion between the substrate and the metal layer. However, the interface between the metal pattern finally obtained and the substrate consequently has an uneven surface. Accordingly, when used as electric wiring, the final product has a decreased high frequency property. Further, the roughening the substrate requires treatment of the substrate with strong acid such as chromic acid, which is complicated.

To solve the problem, a method was proposed in which a radically polymerizable compound is grafted on the substrate surface to reform the surface, thereby suppressing subsequent surface roughness to a minimum level and simplifying the process of the substrate (see, for example, Japanese Patent Application Laid-Open (JP-A) No. 58-196238, and Advanced Materials, Vol. 20, pp. 1481-1494). However, this method requires very expensive equipment (e.g., a gamma-ray generating apparatus, or an electron generating apparatus). Besides, since the substrate is a general, commercially available plastic substrate, the graft polymer is not formed thereon sufficiently to allow firm bond of the electrically conductive material to the graft polymer, and the adhesion of the substrate and the electrically conductive layer is at a practically unacceptable level. When a metal layer formed on the substrate by this method is patterned by the subtractive method, there are some problems peculiar to the subtractive method. That is, to form a fine and narrow metal pattern by the subtractive method, the subtractive method preferably utilizes a so-called overetching method, which can provide lines (obtained by the etching) narrower than the width of the lines of the resist image. However, when a fine metal pattern is directly formed by the overetching method, uneven or unclear lines, or disconnection of lines is likely to occur. Therefore, it is difficult to precisely form a metal pattern with lines having a width of 30 μm or smaller. Besides, since the metal film existing in regions other than the pattern portion is removed by etching in the method, a lot of waste occurs, which incurs extra cost for treating the metal waste liquid caused by the etching process.

To solve the above problems, a metal pattern forming technique called a semi-additive method was proposed. In the semi-additive method, a metal (wiring) pattern is formed in regions other than a resist pattern as follows. A thin metal undercoat layer made of, for example, chromium is formed on a substrate by plating, and a resist pattern is formed on the metal undercoat layer, and a metal layer made of, for example, copper is formed by plating on the regions of the metal undercoat layer which are not covered with the resist pattern, and the resist pattern is removed to form a wiring pattern. The wiring pattern serves as a mask when the metal undercoat layer is etched. Since this is an etching-less technique, a pattern with narrow lines having a width of 30 μm or less can be formed easily. Moreover, because metal is deposited only in necessary regions by plating, this technique is environmentally friendly, and can be carried out at low cost. However, this method requires roughening the substrate surface, too, in order to provide strong adhesion between the substrate and the metal pattern, and the interface between the substrate and the metal pattern finally obtained has an uneven surface. Therefore, the final product has a decreased high frequency property when used as electric wiring.

Therefore, there is a need for a surface graft material has strong adhesion to a substrate, and useful for forming an electrically conductive film on a substrate surface having small irregularities, and its manufacturing method. There is also a need for a substrate having thereon a metal layer and having these two features, that is, an electrically conductive material and its manufacturing method. Furthermore, there is a need for an electrically conductive pattern material.

### DISCLOSURE OF THE INVENTION

The invention has been made in view of the above circumstances.

A first aspect of the invention provides a method for manufacturing a surface graft material including forming an insulator layer containing an insulating resin and a polymerization initiator on a substrate, and forming a graft polymer directly bonding to the surface of the insulator layer.

A second aspect of the invention provides a surface graft material manufactured by the above method.

A third aspect of the invention provides a method for manufacturing an electrically conductive material including forming an insulator layer containing an insulating resin and a polymerization initiator on a substrate, forming a graft polymer directly bonding to the surface of the insulator layer, and forming an electrically conductive layer on the graft polymer.

A fourth aspect of the invention provides an electrically conductive material manufactured by the above method.

A fifth aspect of the invention provides an electrically conductive pattern material obtained by etching the electrically conductive material manufactured.

### BEST MODE FOR CARRYING OUT THE INVENTION

In the method for manufacturing a surface graft material of the invention, an insulator layer containing an insulating resin and a polymerization initiator is formed on a substrate made of any material (for example, a glass substrate), and a graft polymer directly bonding to the surface of the insulator layer is formed by conducting surface graft polymerization on the basis of the polymerization initiator contained in the insulator layer. The graft polymer may be formed on the entire surface of the insulator layer, or in a pattern.

It is a primary feature of the invention to form an insulator layer containing a polymerization initiator in an insulating resin, such as an epoxy resin, a polyimide resin, a liquid crystal resin, or a polyarylene resin. Hence, an insulator layer including an insulating resin material having desired characteristics and having polymerization initiating ability can be formed on the surface of a substrate made of any material. Thereafter, a graft polymer directly bonding to, for example, the entire surface of the insulator layer is formed. Thereby, a graft surface material having a smooth surface and allowing any material to bond thereto can be manufactured. When an electrically conductive material is bonded to the graft polymer of this surface graft material, a smooth and uniform electrically conductive film can be formed. To form the graft polymer in a pattern, energy can be applied only to a desired region or regions of the surface of a graft polymer precursor layer by exposure, and the graft polymer directly bonding to the insulator layer can be formed only in the region(s). When an electrically conductive material is bonded to the graft polymer formed in a pattern, an electrically conductive pattern which is fine and has strong adhesion can be formed even on a smooth and uniform substrate.

In the invention, inclusion of the polymerization initiator in the insulating resin enhances adhesion between the insulator layer and the graft polymer, and thus realizes strong adhesion.

The reason for this is not clear, but is thought to be as follows. Containing the polymerization initiator in the insulating resin increases the density of the surface graft polymer, enhances the interaction between the surface graft polymer and the electrically conductive material layer, and thereby reinforces the adhesion therebetween.

This technique is found to be widely applicable to general insulating resins useful in the field of electronic materials, such as polyimide and epoxy resins.

The strong adhesion between the insulator layer formed on the substrate and the electrically conductive material is exhibited by 1) strong and dense bond between the substrate (or insulator layer) and the graft polymer, and 2) bond between the graft polymer and the electrically conductive material due to strong interaction therebetween. To exhibit this, it is important to select a compound having strong interaction with respect to the graft polymer and the electrically conductive material, as well as to include the polymerization initiator in the insulating layer. The invention will be specifically described below.

A method for manufacturing a surface graft material of the invention will be described in sequence.

### Forming Insulator Layer Containing Insulating Resin and Polymerization Initiator on Substrate

The insulating resin of the insulator layer in the invention may be any of known insulating resins used in conventional multilayer laminated boards, build-up substrates, and flexible substrates. The insulating resin can be a thermosetting resin, a thermoplastic resin, or a mixture of at least two of thermosetting and thermoplastic resins. In the invention, an insulator layer is formed which contains the insulating resin and a polymerization initiator. The insulating resin may contain at least one multifunctional acrylate monomer in order to enhance graft reactivity and the strength of the resultant insulator layer. Alternatively, the insulating resin may contain inorganic and/or organic particles for the purpose of enhancing the strength or the electrical characteristics of the insulator layer.

The components of the insulator layer in the invention will be described below.

As described above, the insulating resin can be a thermosetting resin, a thermoplastic resin, or a mixture of at least two of thermosetting and thermoplastic resins. Specific examples of the thermosetting resin include epoxy resin, phenol resin, polyimide resin, polyester resin, bismaleimide resin, polyolefin resin, and isocyanate resin.

Examples of the epoxy resin include cresol novolak epoxy resin, bisphenol A epoxy resin, bisphenol F epoxy resin, phenol novolak epoxy resin, alkylphenol novolak epoxy resin, biphenyl F epoxy resin, naphthalene epoxy resin, dicyclopentadiene epoxy resin, epoxide of condensate of phenol and aromatic aldehyde having at least one phenolic hydroxy group, triglycidyl isocyanurate, and alicyclic epoxy resin. One of these resins may be used alone or two or more of them can be used together. When the insulator layer contains two or more of the above resins, the insulator layer has improved heat resistance.

Examples of the polyolefin resin include polyethylene, polystyrene, polypropylene, polyisobutylene, polybutadiene, polyisoprene, cycloolefin resin, and copolymer of these resins.

The epoxy resin will be more specifically described below.

The epoxy resin usable in the invention is a product obtained by reacting an epoxy compound (A) having two or more epoxy groups in the molecule thereof with a compound (B) having two or more functional groups which react with the epoxy group in the molecule thereof. Each of the functional groups of the compound (B) is selected from a carboxy group, a hydroxy group, an amino group, and a thiol group.

(A) The epoxy compound having two or more epoxy groups in the molecule thereof (including those called epoxy resin) is preferably an epoxy compound having 2 to 50 epoxy groups in the molecule thereof, and more preferably an epoxy compound having 2 to 20 epoxy groups in the molecule thereof. The epoxy group has an oxirane ring structure, and is, for example, a glycidyl group, an oxyethylene group, or an epoxycyclohexyl group. A wide variety of polyvalent epoxy compounds including such compounds are disclosed in Epoxy Resin Handbook edited by Masaki Shimpo and published by Nikkan Kogyo Shimbunsha in 1987, and the epoxy compound usable in the invention may be properly selected therefrom.

Specific examples thereof include bisphenol A epoxy resin, bisphenol F epoxy resin, brominated bisphenol A epoxy resin, bisphenol S epoxy resin, diphenyl ether epoxy resin, hydroquinone epoxy resin, naphthalene epoxy resin, biphenyl epoxy resin, fluorene epoxy resin, phenol novolak epoxy resin, orthocresol novolak epoxy resin, trishydroxyphenylmethane epoxy resin, trifunctional epoxy resin, tetraphenylol ethane epoxy resin, dicyclopentadiene phenol epoxy resin, hydrogenerated bispenol A epoxy resin, nuclear polyol epoxy resin containing bisphenol A, polypropylene glycol epoxy resin, glycidyl ester epoxy resin, glycidylamine epoxy resin, glioxazal epoxy resin, alicyclic epoxy resin, and heterocyclic epoxy resin.

The compound (B) having two or more functional groups which react with the epoxy group in the molecule thereof is preferably at least one of multifunctional carboxylic acid compounds such as terephthalic acid, multifunctional hydroxy group-containing compounds such as phenol resin, and multifunctional amino compounds such as amino resin and 1,3,5-triaminotriazine.

Examples of the thermoplastic resin include phenoxy resin, polyether sulfone, polysulfone, polyphenylene sulfone, polyphenylene sulfide, polyphenyl ether, polyether imide, 1,2-bis(vinylphenylene) ethane resin and resin obtained by modifying this resin with polyphenylene ether resin (Satoshi Amaha et al., Journal of Applied Polymer Science, Vol. 92, 1252-1258, 2004), liquid crystal polymer such as BEXTAR manufactured by Kuraray, and fluorinated resin (PTFE).

### Mixture of Thermoplastic Resin and Thernosetting Resin

One of the thermoplastic resins and the thermosetting resins may be used alone, or two or more of them can be used together. Two or more of them are used together for the purpose of compensating the respective shortcomings with each other and attaining a more excellent effect. For example, since thermoplastic resin such as polyphenylene ether (PPE) has low heat resistance, the resin can be alloyed with, for example, thermosetting resin. For example, PPE is alloyed with an epoxy compound, or triallyl isocyanate. Alternatively, PPE resin having at least one polymerizable functional group is alloyed with thermosetting resin. Cyanate ester resin has the most excellent dielectric characteristics of thermosetting resins, however is hardly used alone. Cyanate ester resin is used as a resin obtained by modifying epoxy resin, maleimide resin, or thermoplastic resin therewith. Such resins are specifically described in Journal of Electronic Technology, No. 9, p. 35, 2002. Epoxy resin and/or phenol resin as the thermosetting resin, and phenoxy resin and/or polyether sulfone (PES) as the thermoplastic resin are used together to obtain improved dielectric characteristics.

### Compound Having Polymerizable Double Bond

The insulator layer may contain other compound(s) according to the purpose of the application. Such a compound is, for example, a compound having at least one radically polymerizable double bond. The compound having at least one radically polymerizable double bond is an acrylate or methacrylate compound. The acrylate compound (or methacrylate compound) usable in the invention needs to have at least one acryloyl group, which is an ethylenically unsaturated group, in the molecule, and otherwise it is not limited. The acrylate compound is preferably a multifunctional monomer from the viewpoints of curing property, and improvement in the hardness and strength of the insulator layer.

The multifunctional monomer preferably used in the invention is preferably an ester of polyhydric alcohol with acrylic acid or methacrylic acid. Examples of the polyhydric alcohol include ethylene glycol, 1,4-cyclohexanol, pentaerythritol, trimethylol propane, trimethylol ethane, dipentaerythritol, 1,2,4-cyclohexanol, polyurethane polyol, and polyester polyol. The polyhydric alcohol is preferably trimethylol propane, pentaerythritol, dipentaerythritol, or polyurethane polyol. The insulator layer may contain two or more types of multifunctional monomers. The multifunctional monomer contains at least two ethylenically unsaturated groups in the molecule thereof, and preferably three or more ethylenically unsaturated groups. The multifunctional monomer is, for example, a multifunctional acrylate monomer having three to six acrylate groups in the molecule. Further, the insulator layer in the invention may contain at least one oligomer having several acrylate groups in the molecule and a molecular weight of several hundreds to several thousands and called urethane acrylate, polyester acrylate, or epoxy acrylate.

Specific examples of the acrylate having three or more acrylic groups in the molecule include polyol polyacrylates such as trimethylol propane triacrylate, ditrimethylol propane tetraacrylate, pentaerythritol triacrylate, pentaerythritol tetraacrylate, dipentaerythritol pentacrylate, dipentaerythritol hexacrylate; and urethane acrylates obtained by reacting polyisocyanate with acrylate containing at least one hydroxy group such as hydroxyethyl acrylate. Alternatively, the compound having at least one polymerizable double bond can also be a resin obtained by reacting the moiety of a thermosetting resin or thermoplastic resin, for example, epoxy resin, phenol resin, polyimide resin, polyolefin resin, or fluorinated resin with methacrylic or acrylic acid. Such a compound is, for example, a compound obtained by (meth)acrylating epoxy resin.

### Type of Polymerization Initiator Added to Insulating Resin

The insulator layer may contain at least one polymerization initiator. The polymerization initiator usable in the invention can be a heat polymerization initiator or a photopolymerization initiator. Examples of the heat polymerization initiator include perioxide initiators such as benzoyl peroxide, and azo initiators such as azoisobutylonitrile. The photopolymerization initiator may be either a low molecular or high molecular compound, and a generally known material may be used as such.

The low molecular photopolymerization initiator can be a known radical generating agent. Examples thereof include acetophenones, benzophenones, Michier's ketones, benzoyl benzoates, benzoins, alpha-acyloxime esters, tetramethyl thiuram monosulfide, trichloromethyl triazine, and thioxanthone. In addition, the radical generating agent may also be a sulfonium salt or an iodonium salt which is ordinarily used as a photoacid generating agent, since such a salt also acts as a radical generating agent by irradiation of light. In order to enhance sensitivity of the insulator layer, the insulator layer may contain at least one sensitizer in addition to the photo radical polymerization initiator. Examples of the sensitizer include n-butylamine, triethylamine, tri-n-butyl phosphine, and thioxanthone derivatives.

Examples of the high molecular photopolymerization initiator include high molecular compounds having at least one active carbonyl group in the side chain and disclosed in JP-A Nos. 9-77891 and 10-45927.

The content of the polymerization initiator(s) in the insulating resin depends on the application of the surface graft material, and is generally about 0.1 to 50 mass %, and more preferably about 1.0 to 30.0 mass %.

### Other Additives

The insulator layer in the invention may be made of a composite including other component(s) as well as the insulating resin(s) and the polymerization initiator(s) in order to reinforce the characteristics of the resin(s), such as mechanical strength, heat resistance, whether resistance, flame retardance, water resistance, and electrical characteristics. Examples of such component(s) include paper, glass fiber, silica particles, phenol resin, polyimide resin, bismaleimide triazine resin, fluorinated resin, and polyphenylene oxide resin. When the insulator layer contains the component(s), the content thereof is preferably in the range of 1 to 200 parts by mass, and more preferably in the range of 10 to 80 parts by mass relative to 100 parts by mass of the resin(s). When the content is less than 1 part by mass, the above property cannot be reinforced. When the content exceeds 200 parts by mass, the strength of the insulator layer is undesirably low, and graft polymerization reaction does not progress.

Shape (Thickness, and/or Surface Roughness)

The insulator layer in the invention may be formed on a substrate. The substrate needs to have a hard surface capable of supporting the insulator layer, and otherwise it is not limited.

The thickness of the insulator layer is generally in the range of 1 μm to 10 mm, and preferably in the range of 10 μm to 1000 μm. The average roughness (Rz), measured by a method which is stipulated in JIS B 0601 (1994) and in which the height of each often points of the insulator layer is measured and the measured values are averaged, of the insulator layer is preferably 3 μm or less, and more preferably 1 μm or less.

When the surface smoothness of the insulator layer is within this range, or the insulator layer has a substantially even surface, such a surface graft material is preferably employed to manufacture a printed wiring board having an extremely fine circuit (for example, circuit pattern with lines having a width of 25 μm or less and spaces having a width of 25 μm or less).

### Forming Graft Polymer Directly Bonding to Surface of Insulator Layer

To form a graft polymer directly bonding to the surface of the insulator layer thus provided, a compound having at least one radically polymerizable unsaturated double bond may be brought into contact with the surface of the insulator layer, and the entire surface of the resultant compound layer may be exposed to light or the compound layer may be pattern-wise exposed to light. The compound having at least one radically polymerizable unsaturated double bond preferably has at least one functional group which can interact with a substance to be bonded to the resultant graft pattern. For example, a polymerizable compound having at least one functional group which can interact with an electrically conductive material is preferably used as the compound having at least one radically polymerizable unsaturated double bond to form an electrically conductive pattern material described later.

The compound having at least one radically polymerizable unsaturated double bond can be brought into contact with the surface of the insulator layer by forming a layer including such a compound, for example, a polymerizable compound having at least one radically polymerizable unsaturated double bond and at least one functional group which can interact with an electrically conductive material (hereinafter called graft polymer precursor layer in some cases) on the surface of the insulator. The graft polymer precursor layer can be formed by a coating method.

The graft polymer precursor layer may contain other component(s) for forming a layer, such as a binder, a viscosity control agent, a surfactant, and/or any other film-forming agent as well as the polymerizable compound.

In the invention, the polymerizable compound may be any of those having at least one “radically polymerizable unsaturated double bond” necessary for the compound to bond to the insulator layer. However, in the method for manufacturing an electrically conductive pattern material of the invention, the polymerizable compound preferably has at least one “functional group which can interact with the electrically conductive material” and which allows the electrically conductive material to bond to the graft polymer, as well as at least one “radically polymerizable unsaturated double bond”, as described above.

Examples of the compound having at least one radically polymerizable unsaturated double bond include those having at least one of vinyl, vinyloxy, allyl, acryloyl, and methacryloyl groups. A compound having at least one of acryloyl and methacryloyl groups has high reactivity and can provide good effects.

Examples of the functional group which can interact with the electrically conductive material include those having a positive charge such as ammonium, and phosphonium groups; acidic groups having a negative charge or dissociable to generate an ion having a negative charge such as sulfonic, carboxyl, phosphoric, and phosphonic groups; and nonionic polar groups such as hydroxy, amide, sulfoneamide, alkoxy, and cyano groups.

The polymerizable compound having at least one radically polymerizable unsaturated double bond, which is one of the requirements recited in the invention, and at least one functional group which can interact with the electrically conductive material may be either a low molecular compound or a high molecular compound. When the polymerizable compound is a high molecular compound, the average molecular weight thereof is selected in the range of 1,000 to 500,000. Such a high molecular compound can be obtained by addition polymerization, such as radical polymerization or anion polymerization, or polycondensation.

Specifically, in the invention, the compound having at least one radically polymerizable unsaturated double bond and at least one functional group which can interact with the electrically conductive material is preferably a hydrophilic polymer, a hydrophilic macromer or a hydrophilic monomer having at least one hydrophilic group, which is a polar group, from the viewpoints of easy adhesion and adsorption of a metal ion or a metal salt, and easy removal of unreacted matters after graft reaction.

### Hydrophilic Monomer

Specific examples of the hydrophilic monomer employable herein include (meth)acrylic acid and alkaline metal and amine salts thereof, itaconic acid and alkaline metal and amine salts thereof, allylamine and hydrohalogenic acid salts thereof, 3-vinylpropionic acid and alkaline metal and amine salts thereof, vinylsulfonic acid and alkaline metal and amine salts thereof, styrenesulfonic acid and alkaline metal and amine salts thereof, 2-sulfoethylene (meth)acrylate, 3-sulfopropylene (meth)acrylate and alkaline metal and amine salts thereof, 2-acrylamide-2-methyl propanesulfonic acid and alkaline metal and amine salts thereof, acid phosphoxypolyoxyethylene glycol mono(meth)acrylate and salts thereof, 2-dimethylaminoethyl (meth)acrylate and hydrohalogenic acid salts thereof, 3-trimethylammonium propyl (meth)acrylate, 3-trimethylammoniumpropyl (meth)acrylamide, N,N,N-trimethyl-N-(2-hydroxy-3-methacryloyloxypropyl)ammonium chloride, 2-hydroxyethyl (meth)acrylate, (meth)acrylamide, N-monomethylol (meth)acrylamide, N-dimethylol (meth)acrylamide, N-vinylpyrrolidone, N-vinylacetamide, and polyoxyethylene glycol mono(meth)acrylate.

### —Hydrophilic Macromonomer—

A method for producing the macromonomer which can be used in the invention can be any of methods suggested in Chapter 2 (“Synthesis of Macromonomers”) of Chemistry and Industry of Macromonomer edited by Yuya Yamashita, and published by IPC Shuppankyoku in Sep. 20, 1989.

Typical examples of the hydrophilic macromonomer employable herein include macromonomers derived from carboxyl group-containing monomers such as acrylic acid and methacrylic acid, sulfonic acid-based macromonomers derived from sulfonic acid monomers such as 2-acrylamide-2-methylpropanesulfonic acid, vinylstyrenesulfonic acid and salts thereof, amide-based macromonomers derived from amide monomers such as (meth)acrylamide, N-vinylacetamide, N-vinylformamide and N-vinylcarboxylic acid amide, macromonomers derived from hydroxyl group-containing monomers such as hydroxyethyl methacrylate, hydroxyethyl acrylate and glycerol monomethacrylate, and macromonomers derived from alkoxy group or ethylene oxide group-containing monomers such as methoxyethyl acrylate, methoxypolyethylene glycol acrylate and polyethylene glycol acrylate. Further, a monomer having a polyethylene glycol chain or polypropylene glycol chain can also be used as the macromonomer usable in the invention.

The molecular weight of the hydrophilic macromonomer is preferably from 250 to 100,000, and more preferably from 400 to 30,000.

### —Hydrophilic Polymer Having at Least One Polymerizable Unsaturated Group—

The term “hydrophilic polymer having at least one polymerizable unsaturated group” used herein means a radically polymerizable group-containing hydrophilic polymer having at least one ethylenically addition-polymerizable unsaturated group such as a vinyl group, an allyl group or a (meth)acrylic group in its molecule. The radically polymerizable group-containing hydrophilic polymer needs to have at least one polymerizable group at one or more of the terminals of the main chain and/or in its side chain(s). The hydrophilic polymer having at least one polymerizable group (at one or more of the terminals of the main chain and/or in its side chain(s)) is hereinafter referred to as a radically polymerizable group-containing hydrophilic polymer.

Such a radically polymerizable group-containing hydrophilic polymer can be synthesized in the following synthesis method. Examples of the synthesis method include a method (a) involving copolymerization of at least one hydrophilic monomer with at least one monomer having at least one ethylenically addition-polymerizable unsaturated group, a method (b) which includes copolymerizing at least one hydrophilic monomer with at least one monomer having at least one double bond precursor, and then treating the resultant copolymer with, for example, a base so as to incorporate at least one double bond into the copolymer, and a method (c) involving reaction of the functional group(s) of a hydrophilic polymer with at least one monomer having at least one ethylenically addition-polymerizable unsaturated group. The synthesis method is preferably the method (c) from the standpoint of synthesis adaptability.

The hydrophilic monomer to be used in the methods (a) and (b) has at least one hydrophilic group such as a carboxyl group, a sulfonic group, a phosphoric group, an amino group or a salt thereof, a hydroxyl group, an amide group or an ether group. Examples of such a monomer include (meth)acrylic acid and alkaline metal and amine salts thereof, itaconic acid and alkaline metal and amine salts thereof, 2-hydroxyethyl (meth)acrylate, (meth)acrylamide, N-monomethylol (meth)acrylamide, N-dimdethylol (meth)acrylamide, allylamine, hydrohalogenic acid salts thereof, 3-vinylpropionic acid and alkaline metal and amine salts thereof, vinylsulfonic acid and alkaline metal and amine salts thereof, 2-sulfoethyl (meth)acrylate, polyoxyethylene glycol mono(meth)acrylate, 2-acrylamide-2-methylpropanesulfonic acid, acid phosphoxypolyoxyethylene glycol mono(meth)acrylate.

Examples of the hydrophilic polymer used in the method (c) include hydrophilic homopolymers and copolymers obtained by polymerizing at least one selected from the above hydrophilic monomers.

The monomer having at least one ethylenically addition-polymerizable unsaturated group and copolymerizable with the hydrophilic monomer in synthesizing the radically polymerizable group-containing hydrophilic polymer in the method (a) is, for example, an allyl group-containing monomer. Specific examples thereof include allyl (meth)acrylate, and 2-allyloxyethyl methacrylate. The monomer having at least one double bond precursor and copolymerizable with the hydrophilic monomer in synthesizing the radically polymerizable group-containing hydrophilic polymer in the method (b) is, for example, 2-(3-chloro-1-oxopropoxy)ethyl methacrylate. In the method (c), at least one unsaturated group is preferably introduced into the hydrophilic polymer by utilizing reaction of the carboxyl group, or the amino group or the salt thereof in the hydrophilic polymer with at least one functional group such as a hydroxyl group or an epoxy group in synthesizing the radically polymerizable group-containing hydrophilic polymer. Examples of the monomer having at least one addition-polymerizable unsaturated group and used in such introduction include (meth)acrylic acid, glycidyl (meth)acrylate, allyl glycidyl ether, and 2-isocyanatoethyl (meth)acrylate.

The radically polymerizable group-containing hydrophilic polymer indispensably contains at least one radically polymerizable unsaturated double bond and at least one functional group which can interact with the electrically conductive material as the structural moieties, and may be a copolymer obtained by copolymerizing three or four monomers including not only the above raw materials but also other copolymerizable component(s) to improve the properties of a precursor layer and adhesion between the graft polymer and the insulator layer provided on the substrate.

Examples of other copolymerizable component include alkyl acrylates such as methyl (meth)acrylate and butyl (meth)acrylate, 2-methoxyethyl (meth)acrylate, ethylene glycol (meth)acrylate such as polyethylene glycol acrylate and polypropylene glycol acrylate.

### [Other Components Containable in Graft Polymer Precursor Layer]

### Binder

The graft polymer precursor layer may contain at least one binder, as desired. The binder is used together with the radically polymerizable group-containing hydrophilic compound to form the precursor layer. When the radically polymerizable group-containing hydrophilic compound itself can form a film, the binder is unnecessary. However, when the precursor layer includes a monomer having a low viscosity as one of the components thereof, the precursor layer preferably contains a binder to enhance the layer-forming property of the precursor layer. For this purpose, the binder needs to be mixed with the polymerizable group-containing hydrophilic compound and form a film, but otherwise it is not limited. The binder is preferably a water-soluble oligomer or polymer with a molecular weight of 500 or more.

Examples of such a polymer include synthetic polymers including (meth)acrylate polymer and cellulose polymer, such as polyacrylic acid, polymethacrylic acid, polyvinyl alcohol, polybutyral, polyvinyl pyrrolidone, polyethylene oxide, polyethylene imine, polyacrylamide, carboxymethyl cellulose, and hydroxyethyl cellulose; and natural hydrophilic polymers such as gelatin, starch, gum arabic, and sugar.

### Plasticizer, Surfactant and Viscosity Control Agent

The precursor layer may include any of plasticizers, surfactants and viscosity control agents to give flexibility to the precursor layer and, even when a half-finished product having the substrate, the insulator layer, and the precursor layer, which is in a film state, is bent, prevent the precursor layer from cracking. The plasticizer may be a generally used, known material.

### Solvent

The graft polymer precursor layer preferably used in the invention can be formed by dissolving the above components in a proper solvent, applying the resultant solution to the insulator layer and drying the coating.

The solvent can be water and/or at least one organic solvent. The organic solvent is either hydrophilic or hydrophobic, and preferably has high affinity for water, Specific examples thereof include alcohols such as methanol, ethanol, and 1-methoxy-2-propanol; ketones such as acetone, and methyl ethyl ketone; ethers such as tetrahyhdrofuran; and nitirile group-containing solvents such as acetonitrile.

The thickness of the graft polymer precursor layer is preferably in the range of 0.5 μm to 10 um. When the graft polymer precursor layer has a thickness within this range, the graft polymer layer obtained has a desired thickness. Moreover, for example, when the electrically conductive material is bonded to the graft polymer layer in the subsequent process, strong adhesion between the graft polymer layer and the electrically conductive material is ensured.

The thickness of the graft polymer layer obtained by exposing the entire surface of the graft polymer precursor layer to light is preferably in the range of 0.1 μm to 0.7 um. Hence, when the thickness of the graft polymer precursor layer exceeds 10 um, the amount of a part of the precursor layer which part does not contribute to graft polymer formation increases. This increases cost, and, since exposure light is unlikely to reach the deep part of the precursor layer, makes it difficult to remove unnecessary portions of the graft polymer precursor layer.

### Forming Graft Polymer on Surface of Insulator Layer

When the graft polymer precursor layer thus formed on the insulator layer is exposed to light, the insulator layer generates radicals in the exposed region(s), and the radicals react with the component(s) of the graft polymer precursor layer to form strong chemical bond at the interface between the insulator layer and the precursor layer, and a graft polymer is thus formed in the exposed region(s).

### Application of Energy

In the invention, energy is applied to the entire surface or a part of the graft polymer precursor layer to form a graft polymer on the entire surface or a part of the insulator layer. Specifically, the graft polymer is formed by applying heat or irradiating light or radiation beams. The heat source can be a heater or an infrared ray-emitting device. The light source is, for example, a mercury lamp, a metal halide lamp, a xenon lamp, a chemical lamp, or a carbon arc lamp. The radiation can be electron rays, X-rays, ion beams, far infrared rays, g-rays, i-rays, deep UV light, or high-density energy beams (laser beams).

Examples of the laser include gas lasers such as a carbon dioxide laser, a nitrogen laser, an Ar laser, a He/Ne laser, a He/Cd laser, and a Kr laser; liquid (pigment) lasers; solid lasers such as a ruby laser, and a Nd/YAG laser; and a GaAs/GaAlAs laser, an InGaAs laser, blue light-emitting semiconductor lasers, a KrF laser, a XeCl laser, a XeF laser, and excimer lasers of Ar². The laser is preferably a solid-state high output infrared ray laser such as a semiconductor laser and a YAG laser which emit infrared rays having a wavelength of 700 to 1200 nm.

When pattern exposure of high resolution is conducted, stepper exposure such as i-ray stepper, Kr stepper, or ArF stepper can be used.

Alternatively, pattern exposure may be conducted using a mask pattern and a parallel light source. However, from the viewpoint of efficient formation of a desired pattern, pattern exposure is preferably conducted by irradiating light beams according to digital data. This exposure method allows easy formation of a fine graft polymer pattern corresponding to the precision of the exposure light source.

A material, the type of which depends on the functional group(s) of the graft polymer, can be bonded to the graft polymer so as to obtain a functional material. The graft polymer is useful in forming an electrically conductive film, which can be formed by adding an electrically conductive material to the graft polymer, and which has strong adhesion even to a smooth insulator layer. Moreover, when an electrically conductive film is formed on the graft polymer pattern obtained by pattern exposure, a fine electrically conductive pattern can be formed.

### Forming Electrically Conductive Material on Graft Polymer Directly Bonding to Surface of Insulator Layer

The graft polymer is preferably provided with electrical conductivity by any of bonding electrically conductive fine particles to the graft polymer (bonding of electrically conductive fine particles) (method (1)), providing metal ions or at least one metal salt for the graft polymer (providing of metal ion or salt), and reducing the metal ions or the metal ions contained in the metal salt(s) to deposit at least one metal (formation of metal (fine particle) film) (method (2)), providing an electroless plating catalyst or its precursor for the graft polymer (providing of electroless plating catalyst or its precursor) and then conducting electroless plating (electroless plating) (method (3)), and providing at least one electrically conductive monomer for the graft polymer (providing of electrically conductive monomer), and conducting polymerization reaction of the monomer(s) to form an electrically conductive polymer layer (formation of electrically conductive polymer) (method (4)). Further, at least two of these methods (1) to (4) may be combined, and electric plating may be added to the combined method to further enhance the electrical conductivity of the electrically conductive material layer. After the electrically conductive material is bonded, the resultant may be heated.

In the invention, the method (2) may include causing the graft polymer which is obtained by polymerizing at least one compound having at least one polar group (ionic group) to adsorb the metal ions (method (2-1)), or impregnating at least one metal salt or a solution containing at least one metal salt into the graft polymer which is a nitrogen-containing polymer having high affinity for the metal salt such as polyvinyl pyrrolidone, polyvinyl pyridine, or polyvinyl imidazole (method (2-2)).

In the method (3), a graft polymer having at least one functional group which interacts with an electroless plating catalyst or its precursor is prepared, and an electroless plating catalyst or its precursor is provided for the graft polymer, and electroless plating is conducted to form a metal thin film. Since the graft polymer having at least one functional group which interacts with the electroless plating catalyst or its precursor directly bonding to the substrate in this method, the metal thin film has high strength and wear resistance as well as electrical conductivity. When electrolytic plating is conducted using the resultant electroless plating film as an electrode, an electrically conductive film having a desired thickness can be formed easily.

### (1) Bonding of Electrically Conductive Fine Particles

Here, electrically conductive fine particles are directly bonded to the polar group(s) of the graft polymer, and, specifically, the following electrically conductive fine particles are electrostatically or ionically bonded to (adsorbed by) the polar group(s).

The electrically conductive fine particles which can be used in the invention need to have electrical conductivity and otherwise they are not limited. The electrically conductive fine particles can be selected from those made of known electrically conductive materials. The electrically conductive fine particles can be made of at least one of inorganic and organic materials. Typical examples of the inorganic material include metals such as Au, Ag, Pt, Cu, Rh, Pd, Al and Cr; oxide semiconductors such as In₂O₃, SnO₂, ZnO, CdO, TiO₂, CdIn₂O₄, Cd₂SnO₂, Zn₂SnO₄ and In₂O₃—ZnO; those obtained by doping these materials with at least one impurity; spinel-type compounds such as MgInO and CaGaO; electrically conductive nitrides such as TIN, ZrN and HfN; and electrically conductive borides such as LaB. The organic material can be an electrically conductive polymer.

When the graft polymer has at least one anionic polar group, an electrically conductive film is formed by allowing the graft polymer to adsorb electrically conductive fine particles having a positive charge. Such cationic electrically conductive fine particles used herein are, for example, metal (oxide) fine particles having a positive charge. Alternatively, when the graft polymer has at least one cationic polar group, the graft polymer adsorbs electrically conductive fine particles having a negative charge so as to form an electrically conductive film.

The average diameter of the electrically conductive fine particles is preferably in the range of 0.1 nm to 1,000 nm, and more preferably 1 nm to 100 nm. When the average diameter is less than 0.1 nm, large parts of the surfaces of such fine particles come into contact with each other, which tends to result in decreased electrical conductivity. When the average diameter is larger than 1000 nm, a part of each of the electrically conductive fine particles which part interacts with and bonds to the functional group having the opposite polarity is small, which tends to result in decreased adhesion between the hydrophilic surface and the particles and decreased strength of the electrically conductive region(s).

### (2) Providing Metal Ions or Metal Salt, and Reducing Metal Ions or Metal Ions Contained in Metal Salt to Deposit Metal

In the method (2), an electrically conductive film is formed by providing metal ions or at least one metal salt for the graft polymer (providing of metal ion or salt), and reducing the metal ions or the metal ions contained in the at least one metal salt to deposit at least one metal (formation of metal (fine particle) film). Specifically, in the method (2), the functional group(s) of the graft polymer such as a hydrophilic group allows bonding of the metal ions or the at least one metal salt thereto or adsorbs the metal ions or the at least one metal salt according to its function, and the adsorbed metal ions are reduced to deposit at least one metal, which is a simple substance, in the regions having the graft polymer. The metal deposited is in the form of a metal thin film or a layer in which metal fine particles are dispersed according to the way of the deposition.

### (3) Providing Electroless Plating Catalyst or its Precursor and Conducting Electroless Plating

In the method (3), the graft polymer has at least one functional group which interacts with an electroless plating catalyst or its precursor, and an electroless plating catalyst or its precursor is provided for the graft polymer (providing of electroless plating catalyst or its precursor), and electroless plating is then conducted (electroless plating) to form a metal thin film, or an electrically conductive film. In other words, the functional group(s) (i.e., polar group) of the graft polymer interacts with the electroless plating catalyst or its precursor and electroless plating is subsequently conducted to form a metal thin film in the method (3).

As a result, metal (fine particle) film is formed. When a metal thin film (continuous layer) is formed, the film serves as a region having very high electrical conductivity. After the fine particles are adsorbed, the resultant can be heated to improve the electrical conductivity of the electrically conductive material layer.

The “providing of metal ion or salt” and “formation of metal (fine particle) film” in the method (2) will be further described hereinafter.

### <Providing of Metal Ion or Salt>

### Metal Ion and Metal Salt

The metal ions and the at least one metal salt will be described hereinafter.

To enable providing of metal ions for the region(s) having the graft polymer, the metal salt which can be used in the invention needs to be dissolved in a proper solvent and dissociate into the metal ion and a base (anion), and otherwise it is not limited. Examples of the metal salt include M(NO₃)ₙ, MCl_{2/n}(SO₄), and M_{3/n}(PO₄) (in which M represents a metal atom having a valence of n). The metal ions are preferably those obtained by the dissociation of the metal salt. Specific examples of the metal of the metal ions include Ag, Cu, Al, Ni, Co, Fe, and Pd. Silver is preferably used to form an electrically conductive layer. Cobalt is preferably used to form a magnetic layer.

### Method for Providing Metal Ion or Metal Salt

When the graft polymer has at least one ionic group (hydrophilic group) and the ionic group is allowed to adsorb a metal ion in providing metal ions or at least one metal salt for the region having the graft polymer, the metal salt can be dissolved in a suitable solvent, and the resultant solution may be applied to the graft polymer formed above a part of the surface of the substrate or above the entire surface of the substrate. Alternatively, the substrate having thereon the graft polymer may be dipped in the solution. By bringing the solution containing the metal ions into contact with the graft polymer formed on the substrate, the metal ions can be ionically adsorbed by the ionic groups. In order to cause sufficient adsorption, the concentration of the metal ion or the metal salt in the solution to be brought into contact with the graft polymer is preferably from 1 to 50% by mass, and more preferably from 10 to 30% by mass. The time during which the graft polymer is brought into contact with the solution is preferably from about 10 seconds to 24 hours, and more preferably from about 1 minute to 180 minutes.

### <Formation of Metal (Fine Particle) Film>

### Reducing Agent

In the invention, a reducing agent is used to reduce the metal salt or metal ions adsorbed by or contained in the graft polymer and form a metal (fine particle) film. The reducing agent needs to have a physical property by which the metal ions or salt can be reduced to deposit the metal(s), and otherwise it is not limited. Examples of the reducing agent include hypophosphites, tetrahydroborates, and hydrazine.

The reducing agent may be properly selected depending on the type(s) of the metal salt(s) or the metal ions. For example, when an aqueous solution of silver nitrate is used as an aqueous solution of a metal salt for supplying metal ions or a metal salt, the reducing agent is preferably sodium tetrahydroborate. When an aqueous solution of palladium dichloride is used, the reducing agent is preferably hydrazine.

A method for adding the reducing agent to the metal ions can be any of the following two methods. In the first method, the metal ions or the at least one metal salt is provided for the graft polymer formed on the substrate, and the resultant is washed to remove excessive metal salt or metal ions. Thereafter, the substrate having the graft polymer for which the metal ions or the metal salt is provided is immersed in water such as deionized water, and the reducing agent is added to the water. In the second method, an aqueous solution having a predetermined concentration of a reducing agent is directly coated or dripped on the graft polymer which is disposed on the surface of the substrate and for which the metal ions or the metal salt(s) has been provided. The amount of the reducing agent is preferably equal to or more than the equivalence of the metal ions or the metal salt(s), and more preferably 10 times the equivalence or more.

The existence of a uniform metal (fine particle) film having high strength and generated by adding the reducing agent can be visually confirmed by checking whether the surface has metal luster. The structure of the film can be confirmed by observing the surface with a transmission electron microscope or an atomic force microscope (AFM). The thickness of the metal (fine particle) film can be easily measured by an ordinary method, for example, observing the cross section of the film with an electron microscope.

[Relation Between Polarity of Functional Group of Graft Polymer and Metal Ion or Metal Salt]

When the graft polymer has at least one functional group having a negative charge, the at least one functional group adsorbs at least one metal ion having a positive charge, and the adsorbed metal ion(s) is reduced, and at least one region where the metal serving as a simple substance has deposited (metal thin film or metal fine particle) is formed. When the graft polymer has at least one anionic group serving as a hydrophilic functional group such as a carboxylic group, a sulfonic group, or a phosphonic group, the graft polymer selectively has at least one negative charge, and the anionic group is allowed to adsorb a metal ion having a positive charge, and the adsorbed metal ion is reduced, and thereby a metal (fine particle) film region (for example, wiring) is formed.

On the other hand, when the graft polymer chain has at least one cationic group such as an ammonium group, as disclosed in JP-A No. 10-296895, the graft polymer selectively has at least one positive charge, and a solution containing the metal ions or a solution obtained by dissolving the at least one metal salt in a solvent is impregnated into the graft polymer, and the metal ions or the metal ions derived from the at least one metal salt contained in the impregnated solution are reduced, and thereby a metal (fine particle) film region (wiring) is formed.

The metal ions are preferably bonded so that the amount thereof is the maximum that can be provided for (adsorbed by) the hydrophilic groups of the hydrophilic surface, from the viewpoint of durability.

Examples of a method for providing a metal ion to a hydrophilic group include a method which includes applying a solution or dispersion liquid in which metal ions or at least one metal salt is dissolved or dispersed to the surface of a support (coating method), and a method which includes dipping the surface of a support in a solution or dispersion liquid in which metal ions or at least one metal salt is dissolved or dispersed (dipping method). In both the coating method and dipping method, the time during which the solution or dispersion liquid is brought into contact with the surface of the support is preferably from about 10 seconds to 24 hours, and more preferably from about 1 minute to 180 minutes so as to supply an excessive amount of the metal ions to the surface and to form a sufficient ionic bond between the metal ion and the hydrophilic group.

Here, one kind of metal ions can be used and, if necessary, at least two kinds of metal ions can also be used. In order to obtain a desired electrical conductivity, a plurality of materials may be previously mixed. In the electrically conductive film in the invention, metal particles are densely dispersed in the surface graft polymer layer. This can be confirmed by observing the surface or the cross section of the electrically conductive film with SEM or AFM. The size of the metal particles thus prepared is from about 1 μm to 1 nm.

When the electrically conductive film prepared in the aforementioned manner has metal particles densely adsorbed thereto and looks a metal thin film, the electrically conductive film may be used as it is. However, in order to ensure efficient electrical conductivity, the electrically conductive film is preferably heated.

The heating temperature in the heating is preferably 100° C. or more, more preferably 150° C. or more, and still more preferably about 200° C. The heating temperature is preferably 400° C. or less, considering treatment efficiency and dimensional stability of the support. The heating time is preferably 10 minutes or more, and more preferably from about 30 minutes to 60 minutes. Although the mechanism of action of the heating is unclear, it is thought that some adjacent metal particles fuse to enhance the electrical conductivity of the electrically conductive film.

The “providing of electroless plating catalyst or its precursor” and “electroless plating” in the method (3) to provide the graft polymer with electrically conductivity will be described hereinafter.

### Providing of Electroless Plating Catalyst or its Precursor

Here, the electroless plating catalyst or the precursor thereof is provided for the graft polymer formed in the aforementioned manner.

### Electroless Plating Catalyst

The electroless plating catalyst used herein is mainly a metal having a valence of zero, and examples thereof include Pd, Ag, Cu, Ni, Al, Fe and Co. In the invention, the electroless plating catalyst is preferably Pd or Ag from the viewpoints of excellent handling property and high catalyst power. For example, metal colloid which has an adjusted charge and, therefore, can interact with the functional group(s) of the graft polymer is applied to the region(s) having the graft polymer to fix the metal having a valence of zero at the region(s). Generally, the metal colloid can be produced by reducing metal ions in a solution which includes a surfactant having a charge or a protecting agent having a charge. The charge of the metal colloid can be adjusted by the surfactant or the protecting agent. The metal colloid (electroless plating catalyst) having an adjusted charge can be allowed to adhere to the graft polymer by the interaction of the metal colloid with the functional group(s) (polar group(s)) of the graft polymer.

### Electroless Plating Catalyst Precursor

The electroless plating catalyst precursor used herein needs to become the electroless plating catalyst through chemical reaction, and otherwise it is not limited. The ions of the metal having a valence of zero and used as the electroless plating catalyst (metal ions) are mainly used as such. The metal ions, which are the electroless plating catalyst precursor, become the metal having a valence of zero and serving as the electroless plating catalyst through reduction reaction. The metal ions may be applied to the substrate in the method (b), and changed to the metal having a valence of zero, or the electroless plating catalyst, through reduction reaction and the metal, together with the substrate, may be then immersed in an electroless plating bath. Alternatively, the metal ions, together with the substrate, may be immersed in an electroless plating bath and changed to the metal (electroless plating catalyst) by the reducing agent contained in the electroless plating bath.

In fact, the metal ions are applied to the graft polymer in the form of a metal salt. The metal salt needs to be dissolved in a suitable solvent and dissociate into the metal ion and a base (anion), and otherwise it is not limited. Examples thereof include M(NO₃)ₙ, MClₙ, M_{2/n}(SO₄), and M_{3/n}(PO₄) (M represents a metal atom having a valence of n). Specific examples of the metal ions include Ag ions, Cu ions, Al ions, nickel ions, Co ions, Fe ions and Pd ions, and the metal ions are preferably Ag ions and/or Pd ions in view of catalyst power.

The metal colloid, which is the electroless plating catalyst, or the metal salt, which is the electroless plating catalyst precursor, can be applied to the graft polymer as follows. The metal colloid is dispersed in a suitable dispersion medium, or the metal salt is dissolved in a suitable solvent to prepare a dispersion liquid or solution containing the metal ions obtained through the dissociation of the metal colloid or the metal salt. The dispersion liquid or solution may be coated on the graft polymer bonding to the insulator layer formed on the substrate. Alteniatively, the substrate having thereon the graft polymer may be immersed in the solution or dispersion liquid. The metal ions can adhere to the functional group(s) of the graft polymer by bringing the graft polymer into contact with the solution or dispersion liquid. Here, the bond between the metal ion and the functional group is due to ion to ion interaction or dipole to ion interaction. Alternatively, the graft polymer can be impregnated with the metal ions. It is preferable that the metal ion concentration or metal salt concentration of the solution or dispersion liquid is within the range of 0.01 to 50 mass % and more preferably 0.1 to 30 mass % from the viewpoint of sufficient bond or impregnation. The contact time is preferably about 1 minute to about 24 hours, and more preferably about 5 minutes to about 1 hour.

### Electroless Plating

Here, a high-density electrically conductive film (metal film) is formed by subjecting the graft polymer to which the electroless plating catalyst has been applied to electroless plating. The electrically conductive film (metal film) has excellent electrical conductivity and strong adhesion to the graft polymer.

The electroless plating means an operation for chemically changing metal ions to be deposited which are contained in a solution to the metal, which is solid.

In the electroless plating, for example, the substrate to which the electroless plating catalyst has been applied is washed to remove excessive electroless plating catalyst (metal) from the substrate, and then immersed in an electroless plating bath. A generally known electroless plating bath can be used as the electroless plating bath.

When the substrate having thereon the graft polymer bonded to or impregnated with the electroless plating catalyst precursor is immersed in the electroless plating bath, the substrate is washed to remove excessive precursor (for example, metal salt) before the immersion. In this case, the precursor is reduced and the electroless plating is then carried out in the electroless plating bath. A generally known electroless plating bath can be used as the electroless plating bath used herein.

Generally, the electroless plating bath mainly contains (1) metal ions for plating, (2) a reducing agent and (3) an additive agent for enhancing stability of the metal ions (stabilizer). In addition to these, any other known additive such as a stabilizer for plating bath may be contained in the electroless plating bath.

As the metal(s) of the metal ions contained in the electroless plating bath, copper, tin, lead, nickel, gold, palladium and rhodium are known. The metal is preferably copper or gold from the viewpoint of electrical conductivity.

The reducing agent(s) and the additive(s) are suitably selected according to the type(s) of the metal(s). For example, an electroless plating bath for copper plating contains CU(SO₄)₂ serving as a copper salt, HCOH serving as a reducing agent, and a chelating agent, such as EDTA or Rochelle salt, serving as an additive or a stabilizer for copper ions. A plating bath used for electroless plating of CoNiP contains cobalt sulfate and nickel sulfate serving as metal salts, sodium hypophosphite serving as a reducing agent, and sodium malonate, sodium malate and/or sodium succinic acid serving as a complex-forming agent or agents. An electroless plating bath for palladium plating contains (Pd (NH₃)₄) Cl₂ which is to serve as metal ions, NH₃, or H₂NNH₂ serving as a reducing agent and EDTA serving as a stabilizer Ingredients other than the above ingredients may be contained in the respective plating baths.

The thickness of the electrically conductive film (metal film) formed in the above manner can be adjusted by controlling, for example, the metal salt or metal ion concentration of the plating bath, the immersion time during which the substrate is immersed in the plating bath and/or the temperature of the plating bath. The thickness is preferably 0.5 μm or more, and more preferably 3 μm or more from the viewpoint of electrical conductivity. The immersion time is preferably within the range of about 1 minute to about 3 hours, and more preferably about 1 minute to about 1 hour.

The SEM observation of the cross section of the electrically conductive film (metal film) shows that the electroless plating catalyst and the plating metal fine particles are densely dispersed in the surface graft polymer layer and that the comparatively large particles are deposited thereon. The interface between the graft polymer and the electrically conductive film is in a hybrid state of the graft polymer and the fine particles. Therefore, even when the size of the irregularities of the interface between the graft polymer (organic component) and the inorganic substance (i.e., electroless plating catalyst or plating metal) is 100 nm or less, the inorganic substance firmly adheres to the graft polymer.

### Electroplating

The method (3) may further contain electroplating after the electroless plating.

Here, electroplating can be carried out while the metal film (electrically conductive film) formed by the electroless plating is used as an electrode. Thus, a metal film having an arbitrary thickness can be easily formed on the substrate by depositing a metal, which is obtained through the electroplating, on the metal film which has been formed through the electroless plating and which has strong adhesion to the substrate. A metal film having a thickness suitable for the purpose can be formed by adding the electroplating to the method (3). An electrically conductive material obtained by such an embodiment is suitably applied to various applications.

A method of electroplating can be any of conventional methods. Examples of the metal(s) used in the electroplating include copper, chromium, lead, nickel, gold, silver, tin, and zinc. The metal is preferably copper, gold or silver, and is more preferably copper from the viewpoint of electrical conductivity.

The thickness of the metal film obtained by the electroplating depends on the application, and can be controlled by adjusting, for example, the metal concentration of the plating bath, the immersion time and/or the current density. When the resultant electrically conductive material is used as, for example, general electric wiring, the thickness is preferably 0.3 μm or more, and more preferably 3 μm or more from the viewpoint of electrical conductivity.

For example, the electroplating can be carried out to obtain an electrically conductive material which can be suitably mounted in, for example, IC as well as to form a metal film having a desired thickness in the invention. The plating for this purpose, in which the plating metal is selected from nickel, palladium, gold, silver, tin, solder, rhodium, and platinum, and compounds including at least one of these elements, can be carried out with respect to the electrically conductive film or the metal pattern surface made of, for example, copper.

Hereinafter, the “providing of electrically conductive monomer” and “formation of electrically conductive polymer layer” in the method (4) will be explained.

In the method (4), the functional group(s), preferably ionic group(s), of the graft polymer is allowed to ionically adsorb an electrically conductive monomer explained below, and the electrically conductive monomer is polymerized to form an electrically conductive polymer. This method provides an electrically conductive layer made of the electrically conductive polymer.

This method has the following advantages. Since the electrically conductive polymer is formed by polymerizing the electrically conductive monomer inonically adsorbed by the functional group(s) of the graft polymer, the electrically conductive layer made of the electrically conductive polymer has strong adhesion to the substrate and good durability. Moreover, the thickness and the electrical conductivity of the electrically conductive layer can be controlled by adjusting at least one of the polymerization reaction conditions such as monomer supply speed.

A method for forming such an electrically conductive polymer layer is not particularly specified, however the following method is preferably conducted from the viewpoint of formation of a uniform thin film.

First, the substrate on which the graft polymer has been formed is immersed in a solution containing a polymerization catalyst or a compound having an ability to initiate polymerization such as potassium persulfate or iron (III) sulfate, and a monomer capable of forming an electrically conductive polymer, for example, 3,4-ethylene dioxythiophene, is gradually dripped into the solution, which is being stirred. Thereby, the functional group(s) (ionic group(s)) of the graft polymer for which the polymerization initiator or the ability to initiate polymerization has been provided firmly adsorbs the monomer due to the interaction therebetween, and polymerization reaction of the monomer proceeds to form an extremely thin film of an electrically conductive polymer on the graft polymer provided on the substrate. Thus, a uniform and thin electrically conductive polymer layer is obtained.

The electrically conductive polymer suitable for this method is a high molecular compound having an electrical conductivity of 10⁻⁶ s·cm⁻¹ or more, and preferably 10⁻¹ s·cm⁻¹ or more, and otherwise it is not limited. Specific examples thereof include substituted or unsubstituted electrically conductive polyaniline, polyparaphenylene, polyparaphenylene vinylene, polythiophene, polyfuran, polypyrrole, polyselenophene, polyisothianaphthene, polyphenylene sulfide, polyacetylene, polypyridyl vinylene, and polyazine. One of these may be used alone or two or more of them can be used together according to the purpose. As far as the electrically conductive layer has a desired electrical conductivity, the layer may contain any other polymer which does not have electrical conductivity as well as the electrically conductive polymer. Alternatively, the electrically conductive polymer may be a copolymer obtained by copolymerizing at least one of the monomers of the above polymers and other monomer(s) which does not have electrical conductivity.

Since the electrically conductive monomer itself is strongly adsorbed by the functional group(s) of the graft polymer due to electrostatical or polar interaction therebetween in the invention, the electrically conductive polymer layer formed by polymerizing the monomer has strong interaction with the graft polymer. Therefore, even when the electrically conductive polymer layer is a thin film, the layer has enough strength against friction or scratch.

To ensure the adsorption, the electrically conductive polymer and the functional group(s) of the graft polymer can be such that one of them is a cation and the other is an anion. In this case, the functional group(s) serves as the counter ion for the electrically conductive polymer, and is introduced into the electrically conductive polymer and functions as a doping agent for the electrically conductive polymer, thereby enhancing the electrical conductivity of the electrically conductive polymer layer. Specifically, when styrenesulfonic acid and thiophene are respectively selected as a polymerizable compound having at least one functional group and the raw material of an electrically conductive polymer, polythiophene having at least one sulfonic group (sulfo group) serving as a counter anion is formed at the interface between the graft polymer and the electrically conductive polymer layer due to the interaction of the two monomers, and functions as a doping agent for the electrically conductive polymer.

The thickness of the electrically conductive polymer layer formed on the graft polymer surface is not particularly specified, however is preferably in the range of 0.01 μm to 10 μm, and more preferably in the range of 0.1 μm to 5 μm. When the thickness of the electrically conductive polymer layer is within this range, the layer has sufficient electrical conductivity and transparency. When the thickness is less than 0.01 um, the layer may have insufficient electrical conductivity.

When the electrically conductive material manufactured by the method for manufacturing an electrically conductive material of the invention has an electrically conductive layer above the entire surface of the substrate, an electrically conductive pattern material can be formed by etching the electrically conductive material. The electrically conductive pattern material can also be fabricated by forming an electrically conductive layer on the graft polymer which is formed on the substrate in a pattern.

### Etching Metal Film to Form Metal Pattern

In etching the electrically conductive layer (metal film) serving as the surface layer of the electrically conductive material obtained by the invention, the etching can be conducted by a subtractive method or a semi-additive method.

### “Subtractive Method”

In the subtractive method, a resist layer is formed on the electrically conductive layer (metal film) produced in the above manner (step 1), and the resist layer is pattern-wise exposed to light and developed to form a resist pattern on a part of the electrically conductive layer which should remain (step 2), and unnecessary portions of the electrically conductive layer are removed by etching (step 3), and the resist layer is peeled off (step 4). Thus, a metal pattern is produced. The thickness of the electrically conductive layer (metal film) used herein is preferably 5 μm or more, and more preferably within the range of 5 to 30 μm.

Hereinafter, each of the steps of the subtractive method will be explained.

### (1) Formation of Resist Layer

### Resist

A photosensitive resist is used in step 1, and can be a photo-curable negative resist or a photofusing positive resist which fuses by light exposure. Specifically, the photosensitive resist can be a photosensitive dry film resist (DFR), a liquid resist or an electrodeposition (ED) resist. These resists have the following characteristics, respectively. The photosensitive dry film resist (DFR) can be used in a dry method, and, therefore, is easy to handle. The liquid resist can provide a thin resist layer, and, therefore, can be used to form a pattern having a high resolution. The electrodeposition (ED) resist can provide a thin resist layer, and, therefore, can be used to form a pattern having a high resolution. Also, the ED resist can well fit into the gaps between the irregularities of a surface to be coated, and has strong adhesion. The resist to be used may be suitably selected, considering these characteristics.

### Coating Method

### 1. Photosensitive Dry Film

The photosensitive dry film is generally disposed between a polyester film and a polyethylene film. The photosensitive dry film is pressed against a medium and bonded to the medium with a heat roll, while the polyethylene film is peeled off the photosensitive dry film with a laminater.

### 2. Liquid Resist

A method for coating a liquid resist is, for example, a spray coating method, a roll coating method, a curtain coating method or a dip coating method. The coating method is preferably a roll coating method or a dip coating method to simultaneously coat the both surfaces of a medium.

### 3. Electrodeposition (ED) Resist

The ED resist is obtained by suspending fine particles made of a photosensitive resist in water to form colloids. When a voltage is applied to the electrically conductive layer of the electrically conductive material immersed in the ED resist including the fine particles, which have a charge, the resist deposits on the electrically conductive layer due to electrophoresis. The colloids bond to each other on the electrically conductive layer to form a film.

### (2) Pattern Exposure

### “Exposure”

A layered body having a substrate, an insulator layer, a graft polymer layer, an electrically conductive layer, and a resist film in this order is brought into close contact with a mask film or a dry plate so that the resist film faces the mask film or the dry plate. The resist film is then exposed to light to which the resist film is sensitive through the mask film or the dry plate. When the mask film is used, the layered body is brought into close contact with the mask film with a vacuous baking flame and the resist film is then exposed. When a pattern to be formed has lines with a width of about 100 μm, the exposure source used in the exposure can be a point source. When the pattern has lines with a width of 100 μm or less, the exposure source is preferably a parallel light source.

### “Development”

A developer is used in developing the exposed resist film. The developer needs to dissolve unexposed regions of a photo-curable negative resist or exposed regions of a photo-fusing positive resist, which fuses by exposure, and otherwise it is not limited. An organic solvent or an alkaline solution is mainly used as the developer. An alkaline solution is often used these days, since it is environment-friendly.

### (3) Etching

### “Etching”

Etching is a process of chemically dissolving portions of a metal layer which are not covered with a resist to form an electrically conductive pattern. Generally, the etching is conducted by spraying an etching solution on the metal layer, which is being conveyed with a horizontal conveyor, from the upper and lower sides. The etching solution is an aqueous oxidizing solution, and dissolves and oxidizes the metal layer. Specifically, the etching solution is, for example, a ferric chloride solution, a cupric chloride solution or an alkali etchant. However, the alkali contained in an alkali etchant may cause the resist to peel off. Therefore, the etching solution is generally a ferric chloride solution or a cupric chloride solution.

Since the substrate has a non-roughened surface, on which an insulator layer is formed, in the method of the invention, a portion of the electrically conductive layer which portion is near the interface between the substrate and the insulator layer can be easily removed. Moreover, since the graft polymer connecting the electrically conductive film with the substrate bonds to the insulator layer formed on the substrate with the terminal of the polymer chain and is very mobile, the etching solution can diffuse easily in the graft polymer layer in the etching. Therefore, the portion of the metal layer which portion is near the interface can be easily removed, and a pattern having excellent sharpness can be formed.

### (4) Resist Removal

### “Removal”

Since the resist is unnecessary after completing of fomiation of a metal (electrically conductivity) pattern due to the etching, it is necessary to remove the resist. The resist can be removed by spraying a stripping solution on the resist. The type of the stripping solution depends on the type of the resist. Generally, the removal of the resist is conducted by spraying a solvent or a solution which swells the resist, and swelling and stripping the resist.

### “Semi-Additive Method”

In the semi-additive method, a resist layer is formed on the electrically conductive layer (metal film) formed on the graft polymer (step 1), and the resist layer is pattern-wise exposed to light and developed to form a resist pattern on a part of the electrically conductive layer which should be removed (step 2), and a metal film is formed on the portions of the electrically conductive layer which are not covered with the resist layer by plating (step 3), and the resist layer is peeled off (step 4), and unnecessary portions of the electrically conductive layer are removed by etching (step 5). Thus, a metal pattern is produced. In these steps, the same techniques as in the subtractive method can be used. The plating is either electroless plating or electroplating. The thickness of the metal film is preferably 1 to 3 μm to shorten the time for the etching. The metal pattern may be further subjected to electroplating or electroless plating.

By such etching, an electrically conductive pattern material can be made with the electrically conductive material of the invention. Since the electrically conductive material of the invention has an electrically conductive layer (metal film) having strong adhesion on a smooth substrate, and a fine metal pattern having strong adhesion on a smooth substrate can be made therewith by etching, the electrically conductive material is useful in forming various electric circuits.

An electrically conductive material having excellent characteristics can be obtained by providing an electrically conductive material for the surface graft material obtained by the method for manufacturing a surface graft material of the invention. That is, the invention provides a metal film material having strong adhesion, for example, a coppered laminate, and a metal pattern, for example, a layered body having a substrate, an insulator layer, and highly precise wiring made of copper and preferably used to form a printed wiring board without roughening the surface of an insulating resin material layer having heat resistance and low dielectric constant and used as the substrate for a printed wiring board, such as an epoxy resin, a polyimide resin, a liquid crystal resin, or a polyarylene resin.

The method for forming an electrically conductive layer on the patterned surface graft material of the invention makes it possible to easily form a fine electrically conductive pattern, such as copper wiring, made of an electrically conductive material and having lines with a width of 20 microns or less and strong adhesion, which is difficult to manufacture in the prior art.

### INDUSTRIAL APPLICABILITY

The electrically conductive material obtained by the manufacturing method of the invention can provide a coppered substrate having strong adhesion, and a layered body having a substrate, an insulator layer, and highly precise metal pattern, such as copper wiring, without roughening the surface of an insulating resin material having heat resistance and low dielectric constant, such as an epoxy resin, a polyimide resin, a liquid crystal resin, or a polyarylene resin, and such a coppered substrate and the layered body can be used to form wiring boards in the fields of printed wiring boards and flexible wiring.

### EXAMPLES

The invention will be more specifically described below by referring to specific examples thereof, however the invention is not limited to these examples.

### Examples 1 to 5

### 1. Fabrication of Substrate Having Thereon Insulator Layer Containing Initiator

### Specific Example 1

### Formation of Epoxy Insulator Layer Containing Initiator

Twenty parts by mass (hereinafter, all the blending amounts were expressed by parts by mass) of bisphenol A-type epoxy resin (EPICOAT 828 having an epoxy equivalence of 185 and manufactured by Yuka Shell Epoxy Co.) serving as component (A), 45 pails of cresol novolak-type epoxy resin (EPICHLON N-673 having an epoxy equivalence of 215, and manufactured by Dainippon Ink & Chemicals, Inc.), and 30 parts of phenol novolak resin (PHENOLITE having a phenolic hydroxy group equivalence of 105, and manufactured by Dainippon Ink & Chemicals, Inc.) serving as component (B) were added to 20 parts of ethyl diglycol acetate and 20 parts of solvent naphtha. The resultant system, which was being stirred, was heated to dissolve the above resins in the solvents. Thereafter, the system was cooled down to room temperature. Thirty parts of cyclohexanone varnish of phenoxy resin obtained by polymerizing EPICOAT 828 and bisphenol S (L674H30 manufactured by Yuka Shell Epoxy Co., and having a nonvolatile component content of 30% by mass and a weight-average molecular weight of 47,000) serving as component (C), 0.8 parts of 2-phenyl-4,5-bis(hydroxymethyl) imidazole serving as component (D), 2 parts of finely ground silica, and 0.5 parts of silicone defoaming agent were added to the system.

Ten parts of polymerization initiating polymer P synthesized in the following method was added to the resultant mixture, and the resulting blend was stirred to dissolve the polymer in the mixture. Thus, an epoxy resin varnish containing an initiator was prepared. This epoxy resin varnish was applied to a SUS substrate with a doctor blade, and the resultant coating was heated and dried at 100° C. for 10 minutes, and further heated and dried at 200° C. for 5 minutes to obtain an insulator layer made of a cured epoxy resin and having a thickness of 200 microns on the substrate. The average roughness (Rz) of the insulator layer was 0.8 um.

### Synthesis of Polymerization Initiating Polymer P

Thirty grams of propylene glycol monomethyl ether (MFG) was put into a three-neck flask having a capacity of 300 ml, and heated to 75° C. A solution containing 8.1 g of [2-(acryloyloxy)ethyl] (4-benzoylbenzyl) dimethyl ammonium bromide, 9.9 g of 2-hydroxyethyl methacrylate, 13.5 g of isopropyl methacrylate, 0.43 g of dimethyl-2,2′-azobis (2-methylpropionate), and 30 g of MFG was dripped into the flask over 2.5 hours. Thereafter, the reaction temperature was raised to 80° C., and reaction was conducted for two hours to obtain the polymer P having at least one polymerization initiating group.

### Specific Example 2

### Formation of Epoxy Insulator Layer Containing Initiator

Five grams of liquid bisphenol A-type epoxy resin (EPICOAT 825 having an epoxy equivalence of 176, and manufactured by Japan Epoxy Resin Co.), 2 g of MEK varnish of phenol novolak resin containing at least one triazine structure (PHENOLITE LA-7052 manufactured by Dainippon Ink & Chemicals, Inc., and having a nonvolatile component content of 62%, and a phenolic hydroxy group equivalence of the nonvolatile components of 120), 10.7 g of MEK varnish of phenoxy resin (YP-50EK35 manufactured by Toto Kasei Co., and having a nonvolatile component content of 35%), and, as a polymerization initiator, 2.3 g of 1-(4-(2-hydroxyethoxy)phenyl)-2-hydroxy-2-methylpropan-1-one, 5.3 g of MEK, and 0.053 g of 2-ethyl-4-methylimidazole were mixed with each other. The resultant mixture was stirred, until solid matters completely disappeared in the mixture. Thus, an epoxy resin composition (varnish) was prepared. This epoxy resin composition was applied to a polyimide film having a thickness of 128 μm (CAPTON 500H manufactured by Toray DuPont) with a coating bar, and the resultant coating was dried at 170° C. for 30 minutes. Thus, an epoxy insulator layer containing the initiator and having a dry thickness of 90 μm was formed on the substrate. The average roughness (Rz) of the insulator layer was 0.5 microns.

### Specific Example 3

### Epoxy Insulator Layer Containing Initiator and Polymerizable Double Bond-Containing Compound

A coating solution for an insulator layer was prepared by mixing 70 parts weight of novolak-type epoxy acrylate modified with phthalic anhydride and having an acid value of 73 (PCR-1050 manufactured by Nippon Kayaku Co., Ltd), 20 parts by weight of acrylonitrile-butadiene rubber (PNR-1H manufactured by Nippon Synthetic Rubber Co.), 3 parts by weight of an alkylphenol resin (HITANOL 2400 manufactured by Hitachi Chemical Co., Ltd.), 7 parts by weight of a radical-type photopolymerization initiator (IRGACURE 651 manufactured by Ciba-Geigy AG), 10 parts by weight of aluminum hydroxide (HDILITE H-42M manufactured by Showa Denko k.k.), and 40 parts by weight of methyl ethyl ketone. The coating solution was applied to a glass substrate with a rod bar, and the resultant coating was dried at 110° C. for 10 minutes to obtain an insulator layer. The insulator layer had a thickness of 50 microns, and an average roughness (Rz) of 0.5 microns.

### Specific Example 4

### Phenoxy Ether Insulator Layer Containing Initiator

Fifty grams of a polyphenylene ether resin (PKN4752 manufactured by Nippon GE Plastics Co.), 100 g of 2,2-bis(4-cyanatophenyl)propane (AROCYB-10 manufactured by Asahi Ciba Co.), 28.1 g of 9,10-dihydro-9-oxa-10-phosphaphenanthrene-10-oxide (HCA-HQ manufactured by Sanko Chemical Co.), 0.1 g of a 17% toluene diluted solution of manganese naphthenate (having a Mn content of 6 wt. %, and manufactured by Nippon Chemical Industries, Ltd.), 88.3 g of 2,2-bis(4-glycidylphenyl)propane (DER331L manufactured by Dow Chemical Japan, Ltd.), and, as a polymerization initiator, 3.3 g of 1-(4-(2-hydroxyethoxy)phenyl)-2-hydroxy-2-methylpropan-1-one were added to 183 g of toluene. The resultant mixture was heated at 80° C., until solid matters disappeared in the mixture. Thus, a coating solution was prepared. The coating solution was applied to a glass substrate with a rod bar, and the resultant coating was dried at 110° C. for 10 minutes to form an insulator layer. The insulator layer had a thickness of 50 microns, and an average roughness (Rz) of 0.4 microns.

### Specific Example 5

### Polyether Sulfone Insulator Layer Containing Initiator

A mixture was prepared by blending 70 parts by weight of 25% acrylilated product of a cresol novolak-type epoxy resin dissolved in diethylene glycol dimethyl ether (having a molecular weight of 2,500, and manufactured by Nippon Kayaku Co., Ltd), 30 parts by weight of polyether sulfone, 4 parts by weight of an imidazole hardening agent (2E4MZ-CN manufactured by Shikoku Kasei Co.), 10 parts by weight of caprolactone tris(acryloyloxy)isocyanurate (ARONIX M325 manufactured by Toa Gosei Co.), 5 parts by weight of benzophenone (manufactured by Tokyo Kasei Co.), 0.5 parts by weight of Michler's ketone (manufactured by Tokyo Kasei Co.), and 20 parts by weight of epoxy resin particles having an average diameter of 0.5 microns. An appropriate amount of N-methylpyrrolidone was added to the mixture, which was being stirred. The resultant blend was applied to a glass substrate with a roll coater, and the resultant coating was dried at 140° C. for 10 minutes to form an insulator layer. The insulator layer had a thickness of 70 microns, and an average roughness (Rz) of 0.4 microns.

### 2. Fabrication of Laminated Film Having Graft Polymer Precursor Layer on Insulator Layer

A liquid composition 1 which had the following composition and contained a polymer having at least one acrylic group serving as a polymerizable moiety and at least one carboxylic group serving as a functional group (hydrophilic polymer P-1 having at least one polymerizable group at the side chain(s) and obtained by a synthesis example described later) was applied to each of the insulator layers, which had been formed on the substrates by the above methods of the specific examples 1-5 and which were not subjected to surface treatment and pre-treatment, with a rod bar #6, and the resultant coating was dried at 100° C. for 1 minute to form a graft polymer precursor layer. Thus, laminated films 1 to 5 each having the graft polymer precursor layer on the insulator layer were obtained. The thickness of the graft polymer precursor layer was in the range of 1.0 to 1.5 um.

### Liquid Composition 1 Containing Polymerizable Compound

Hydrophilic polymer P-1 having at least one polymerizable group at the side chain(s)
   3.1 g
Water
   24.6 g
1-Methoxy-2-propanol
   12.3 g

### Synthesis Example

### Synthesis of Hydrophilic Polymer P-1 Having at Least One Polymerizable Group at the Side Chain(s)

Sixty Grams of Polyacrylic Acid (Having an Average Molecular Weight of 25,000, and manufactured by Wako Pure Chemical Industries Ltd.) and 1.38 g (0.0125 mol) of hydroquinone (manufactured by Wako Pure Chemical Industries Ltd.) were put in a three-neck flask having a capacity of one liter and provided with a cooling tube. 700 g of N,N-dimethyl acetamide (DMAc manufactured by Wako Pure Chemical Industries Ltd.) was added to the content of the flask and the resultant mixture was stirred at room temperature to form a uniform solution. 64.6 g (0.416 mol) of 2-methacryloyloxyethyl isocyanate (CARENS MOI manufactured by Showa Denko k.k.) was dripped into the solution, which was being stirred. Subsequently, 0.79 g (1.25×10⁻³ mol) of tin di-n-butyl dilaurate suspended in 30 g of DMAc was dripped into the resultant blend. The obtained mixture, which was being stirred, was heated in a water bath kept at 65° C. Five hours later, the heating was stopped. The resultant reaction solution was naturally cooled down to room temperature. The reaction solution had an acid value of 7.105 mmol/g, and a solid content of 11.83%.

Three hundreds grams of the reaction solution was taken out, put in a beaker, and cooled down to 5° C. in an ice bath. 41.2 mol of a 4N aqueous sodium hydroxide solution was dripped into the reaction solution, which was being stirred, over about 1 hour. The temperature of the reaction solution during the dripping was 5 to 11° C. After the dripping, the reaction solution was stirred at room temperature for 10 minutes to precipitate a solid matter. The solid matter was removed from the reaction solution through suction filtration, and a brown filtrate was obtained. Three liters of ethyl acetate was added to the filtrate to precipitate a solid matter, and the solid matter was taken out by filtration. The solid matter was added to three liters of acetone to form a slurry overnight. The solid matter of the slurry was taken out by filtration, and dried in vacuum for 10 hours, and a pale brown powder P-1 was obtained. A solution obtained by dissolving one g of this polymer in a mixed solvent including 2 g of water and 1 g of acetonitrile had a pH of 5.56, and a viscosity of 5.74 cps. The viscosity was measured with a RE-80-type viscometer manufactured by Toki Sangyo Co., Ltd. at 28° C. A rotor 30XR14 was used in the measurement. The molecular weight of the polymer was measured by GPC and was 30,000.

### 3. Exposure (Formation of Graft Polymer)

The entire surface of each of the laminated films 1 to 5 having the graft polymer precursor layer on the insulator layer was exposed to light, and then cleaned to obtain surface graft materials 1 to 5 having a graft polymer on the insulator layer.

The exposure was executed at room temperature with an exposure device or an ultraviolet irradiation apparatus (UVX-02516S1LP01 manufactured by Ushio Inc.) for 1 minute. The cleaning was conducted by sufficiently washing the exposed materials with purified water.

### 4. Application of Conductivity

An electrically conductive substance was provided for each of the thus-obtained surface graft materials 1 to 5 of the invention in accordance with a method selected from the following two methods and shown in Table 1 to prepare electrically conductive materials of Examples 1 to 5.

### Electrical Conductivity Imparting Method a: Execution of Electroless Plating and Electroplating

The surface graft materials 1 to 3 were immersed in an aqueous solution including 0.1 mass % of silver nitrate (manufactured by Wako Pure Chemical Industries Ltd.) for 1 hour, and washed with distilled water. Thereafter, the surface graft materials were immersed in an electroless plating bath having the following composition for 10 minutes, and subjected to electroplating in an electroplating bath having the following composition for 20 minutes to prepare coppered laminates (electrically conductive materials) of Examples 1 to 3.

<Composition of electroless plating bath>

| | | |
|---|---|---|
| Copper sulfate | 0.3 | g |
| Sodium potassium tartarate | 1.7 | g |
| Sodium hydroxide | 0.7 | g |
| Formaldehyde | 0.2 | g |
| Water | 48 | g |

<Composition of electroplating bath>

| | | |
|---|---|---|
| Copper sulfate | 38 | g |
| Sulfuric acid | 95 | g |
| Hydrochloric acid | 1 | ml |
| Copper glyme PCM (manufactured by Meltex) | 3 | ml |
| Water | 500 | g |

### Electrical Conductivity Imparting Method B: Bonding of Electrically Conductive Particles and Execution of Electroless Plating

The surface graft materials 4 and 5 were immersed in a dispersion liquid, manufactured by the following method, in which Ag particles having a positive charge were dispersed for 1 hour, and washed with distilled water. Thereafter, the surface graft materials were subjected to electroless plating in the same manner as in the electrically conductivity imparting method A so as to prepare coppered laminates (electrically conductive materials) of Examples 4 and 5.

### <Synthesis of Ag Particles Having Positive Charge>

Three grams of bis(1,1-trimethyl ammonium decanoyl aminoethyl)disulfide was added to 50 ml of a 5 mM ethanol solution including silver perchlorate. Thirty milliliters of ammonium borohydride (0.4 M) was slowly dripped into the resultant mixture, which was being stirred thoroughly, to reduce ions. Thus, a dispersion liquid of silver particles coated with the quaternary ammonium compound was obtained.

### Evaluation of Electrically Conductive Material

### Surface Irregularities (Surface Roughness)

The surface roughness of each of the electrically conductive materials was measured with a device (NANOPIX 1000 manufactured by Seiko Instruments Co., and provided with a DFM cantilever). The results are shown in Table 1.

### Measurement of Metal Film Thickness

The thickness of the metal film of each of the electrically conductive materials was measured with a DMF cantilever. The results are shown in Table 1.

### Measurement of Adhesion Strength

A copper plate (thickness of 50 um) was bonded to the metal (copper) film of each of the electrically conductive materials with an epoxy adhesive (ARALDITE manufactured by Ciba-Geigy AG), and the resultant was dried at 140° C. for 4 hours, and subjected to a 90-degree peeling test on the basis of JIS C 6481. The peeling apparatus was a tensile tester AGS-J manufactured by Shimadzu Corporation. The results are shown in Table 1.

TABLE 1

| | | | Elec- | Thick- | | |
|---|---|---|---|---|---|---|
| | | | trical | ness | | |
| | Type of | Type of | conduc- | of | Surface | Adhe- |
| | insu- | surface | tivity | copper | rough- | sion |
| | lator | graft | imparting | layer | ness | strength |
| | layer | material | method | (μm) | (Rz: nm) | (kN/m) |
| Example 1 | 1 | 1 | A | 10 | 200 | 0.9 |
| Example 2 | 2 | 2 | A | 11 | 250 | 1.1 |
| Example 3 | 3 | 3 | A | 8 | 200 | 1.0 |
| Example 4 | 4 | 4 | B | 10 | 300 | 0.9 |
| Example 5 | 5 | 5 | B | 10 | 150 | 1.0 |

As is apparent from Table 1, it is found that the electrically conductive materials obtained by the manufacturing method of the invention have small surface irregularities and a metal film having a sufficient thickness and strong adhesion on a graft polymer layer firmly bonded to a flat insulator layer which is sufficiently bonded to a substrate.

### 4. Formation of Pattern

Fine wiring was made with the electrically conductive materials (coppered laminates) of Examples 1 to 5.

A photosensitive dry film (manufactured by Fuji Photo Film Co., Ltd.) was laminated on each of the electrically conductive materials of Examples 1 to 5, exposed to ultraviolet rays through a mask film which had openings corresponding to a desired conductor circuit pattern (metal pattern) to form a latent image, and developed. Thereafter, portions of the metal film (copper thin film) from which portions the resist had been removed were removed with a cupric (II) chloride etchant. The dry film was then stripped off, and a copper fine pattern was obtained.

The following properties of the electrically conductive patterns were evaluated as follows.

### Pattern Forming Property

The width of thin lines and that of spaces between the thin lines were measured with an optical microscope (OPTI PHOTO-2 manufactured by Nikon Corporation). The results are shown in Table 2.

### Evaluation of Adhesion Strength

A copper plate (thickness of 50 um) was bonded to the metal pattern (line width of 5 mm) with an epoxy adhesive (ARALDITE manufactured by Ciba-Geigy AG), and the resultant was dried at 140° C. for 4 hours, and subjected to a 90-degree peeling test on the basis of JIS C 6481. The peeling apparatus was a tensile tester AGS-J manufactured by Shimadzu Corporation. The results are shown in Table 2.

TABLE 2

| | Pattern forming property | Adhesion strength |
|---|---|---|
| | (line/space) (μm) | (kN/m) |
| Example 1 | 20/20 | 0.9 |
| Example 2 | 15/15 | 1.1 |
| Example 3 | 23/23 | 1.0 |
| Example 4 | 21/21 | 0.9 |
| Example 5 | 15/15 | 1.0 |

As is apparent from Table 2, the electrically conductive patterns made with the electrically conductive materials of the invention have fine wiring having strong adhesion on a graft polymer layer firmly bonded to a smooth insulator layer which is sufficiently bonded to a substrate with small surface irregularities.

### Examples 6 to 10

Surface graft materials 6 to 10 were prepared in the same method as in Examples 1 to 5, except that each of the laminated films was pattern-wise exposed and developed by a method selected from the following three exposure and development methods and shown in Table 3 instead of exposure of the entire surface. In these surface graft materials, a graft polymer was formed in a pattern on the insulator layer.

### Exposure and Development Method 1

A mask pattern formed by evaporating chromium (NC-1 manufactured by Toppan Printing Co., Ltd.) was disposed on each of the laminated films, and the laminated films were exposed to UV light through the mask pattern for one minute with an exposure device (UVX-02516S1LP01 manufactured by Ushio Inc.), and the mask pattern was removed, and the laminated films were sufficiently washed with pure water.

### Exposure and Development Method 2

A mask pattern formed by evaporating chromium (NC-1 manufactured by Toppan Printing Co., Ltd.) was disposed on each of the laminated films, and the laminated films were exposed to UV light emitted by a 400 W high pressure mercury vapor lamp, UVL-400P manufactured by Riko Kagaku Sangyo Co., Ltd. through the mask pattern for 5 minutes, and the mask pattern was removed, and the laminated films were washed with water, and surface graft materials having a graft polymer formed in a pattern was obtained.

### Exposure and Development Method 3

The laminated films were image-wise exposed to light emitted by a laser which emits blue light having a wavelength of 405 nm (beam diameter of 20 um), and washed with water, and surface graft materials having a graft polymer formed in a pattern was obtained.

### Imparting of Electrical Conductivity

An electrically conductive substance was provided for each of the surface graft materials 6 to 10 of the invention in accordance with a method selected from the following three methods and shown in Table 3 to form electrically conductive pattern materials of Examples 6 to 10.

### Electrical Conductivity Imparting Method C: Execution of Electroless Plating

The surface graft material 6 was immersed in an aqueous solution containing 0.1 mass % of silver nitrate (manufactured by Wako Pure Chemical Industries Ltd.) for 1 hour, and washed with distilled water. Thereafter, the surface graft material was immersed in an electroless plating bath having the following composition for 60 minutes to produce an electrically conductive pattern material of Example 6.

### <Electroless Plating Bath Composition>

OPC copper H T1 (manufactured by Okuno Chemical Industries Co., Ltd.) 6 mL
OPC copper H T2 (manufactured by Okuno Chemical Industries Co., Ltd.) 1.2 mL
OPC copper H T1 (manufactured by Okuno Chemical Industries Co., Ltd.) 10 mL
Water 83 mL

### Electrical Conductivity Imparting Method D: Execution of Electroless Plating and Electrolytic Plating

The surface graft materials 7 to 9 were immersed in an aqueous solution containing 0.1 mass % of silver nitrate (manufactured by Wako Pure Chemical Industries Ltd.) for 1 hour, and washed with distilled water. Thereafter, the materials were immersed in an electroless plating bath the same as in Example 1 for 10 minutes, and then immersed in an electroplating bath the same as in Example 1 for 15 minutes 1 to form electrically conductive pattern materials of Examples 7 to 9.

### Electrical Conductivity Imparting Method E: Bonding of Electrically Conductive Particles and Execution of Electroless Plating

The surface graft material 10 was immersed in a dispersion liquid in which Ag particles having a positive charge were dispersed and which was used in Example 5 for 1 hour, and washed with distilled water. Thereafter, the material was subjected to plating the same as in the electrical conductivity imparting method D to produce an electrically conductive pattern material of Example 10.

TABLE 3

| | | | Type of | Electrical |
|---|---|---|---|---|
| | | Exposure and | Surface | conductivity |
| | | development | graft | imparting |
| | Substrate | method | material | method |
| Example 6 | 1 | 1 | 1 | C |
| Example 7 | 2 | 2 | 2 | D |
| Example 8 | 3 | 2 | 3 | D |
| Example 9 | 4 | 2 | 4 | D |
| Example 10 | 5 | 3 | 5 | E |

### Evaluation of Electrically Conductive Pattern

The pattern forming property, surface roughness, metal film thickness, and adhesion strength (adhesion strength of a metal pattern corresponding to each of the electrically conductive patterns and having lines whose width was 5 mm) of the electrically conductive pattern materials 6 to 10 were evaluated in the same manner as in Examples 1 to 5. The results are shown in Table 4.

TABLE 4

| | | Surface | Thickness of | |
|---|---|---|---|---|
| | Pattern forming | roughness | electrically | |
| | property | (pattern | conductive | Adhesion |
| | (lines/space) | portion) | layer | strength |
| | (μm) | (Rz: nm) | (μm) | (kN/m) |
| Example 6 | 10/10 | 200 | 3 | 0.8 |
| Example 7 | 15/15 | 250 | 12 | 1.0 |
| Example 8 | 10/10 | 300 | 18 | 1.1 |
| Example 9 | 10/10 | 100 | 15 | 0.9 |
| Example 10 | 8/8 | 230 | 12 | 1.0 |

As is apparent from Table 4, it has been found that the method for manufacturing an electrically conductive material of the invention can provide fine wiring (electrically conductive material, or metal film pattern) having a sufficient thickness and strong adhesion on a graft polymer layer firmly bonded to an insulator layer which has a smooth surface with small irregularities and sufficiently bonds to a substrate. The electrically conductive (pattern) materials have fine metal wiring corresponding to an exposure pattern, and strong adhesion and smoothness. Hence, they are excellent in high frequency characteristics, and useful as an electrically conductive layer (wiring) of printed wiring boards.

1. A method for manufacturing a surface graft material comprising forming an insulator layer containing an insulating resin and a polymerization initiator on a substrate, and forming a graft polymer directly bonding to the surface of the insulator layer.

2. The method of claim 1, wherein the graft polymer is formed on the entire surface of the insulator layer.

3. The method of claim 1, wherein the graft polymer is formed in a pattern.

4. A surface graft material manufactured by the method of claim 2.

5. A surface graft material manufactured by the method of claim 3.

6. A method for manufacturing an electrically conductive material comprising forming an insulator layer containing an insulating resin and a polymerization initiator on a substrate, forming a graft polymer directly bonding to the surface of the insulator layer, and forming an electrically conductive layer on the graft polymer.

7. The method of claim 6, wherein the graft polymer and the electrically conductive layer are formed on the entire surface of the insulator layer.

8. The method of claim 6, wherein the graft polymer and the electrically conductive layer are formed in a pattern.

9. An electrically conductive material manufactured by the method of claim 7.

10. An electrically conductive material manufactured by the method of claim 8.

11. An electrically conductive pattern material obtained by etching the electrically conductive material manufactured by the method of claim 7.
